(19) United States
(12) Patent Application Publication
(10) Pub. No.: US 2010/0054445 A1
(43) Pub. Date: Mar. 4, 2010

(54) METHOD, APPARATUS AND COMPUTER PROGRAM PRODUCT FOR PROVIDING ROUTING OF MESSAGE SIGNALING

(76) Inventors: Peter Leis, Penzberg (DE); Georg Mayer, Vienna (AT)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/200,320

(22) Filed: Aug. 28, 2008

(51) Int. Cl. H04M 3/42

(52) U.S. Cl. 379/216.01

(57) ABSTRACT

An apparatus for providing routing of message signaling may include a processor. The processor may be configured to receive an indication of a signaling message including at least a partially dialed number, determine whether the dialed number is an incomplete number or a complete number associated with a user identity of a terminating user, forward, in response to a determination that the dialed number is the complete number, the signaling message to a call session control function associated with a location of the terminating user, and delay forwarding of the signaling message until the dialed number is the complete number in response to a determination that the dialed number is the incomplete number. A method and computer program product for providing routing of message signaling is also provided.

### TECHNOLOGICAL FIELD

Embodiments of the present invention relate generally to communications technology and, more particularly, relate to apparatuses, methods and computer program products for enabling the provision of routing for message signaling.

### BACKGROUND

Communication devices are becoming increasingly ubiquitous in the modern world. In particular, mobile communication devices seem to be popular with people of all ages, socio-economic backgrounds and sophistication levels. Accordingly, users of such devices are becoming increasingly attached to their respective mobile communication devices. Whether such devices are used for calling, emailing, sharing or consuming media content, gaming, navigation or various other activities, people are more connected to their devices and consequently more connected to each other and to the world at large.

Due to advances in processing power, memory management, application development, power management and other areas, communication devices, such as computers, mobile telephones, cameras, personal digital assistants (PDAs), media players and many others are becoming more capable. Furthermore, many such devices are becoming capable of performing tasks associated with more than one of the above listed devices and other tasks as well. Thus, for example, users of such devices often have a robust capacity to generate, consume and share content as well as to communicate with each other.

Various communication networks and protocols have developed to support the communication devices described above. Many of these networks and protocols are utilized in the context of the provision of various different services to the users of such devices. As an example, the Internet protocol (IP) multimedia subsystem (IMS) is an architectural framework for delivering Internet services to users of mobile communication devices. However, IMS is merely one example of a number of alternative and overlapping technologies designed to provide wireless or wired access to services. A continued effort is likely to be made to improve the capabilities and respective efficiencies of these technologies. Thus, for example, improvements in support of overlap dialing may be desirable.

### BRIEF SUMMARY OF EXEMPLARY EMBODIMENTS

A method, apparatus and computer program product are therefore provided that may enable routing of message signaling. Thus, support for overlap dialing in an architecture such as, for example, IMS may be provided.

In one exemplary embodiment, a method of providing routing of message signaling is provided. The method may include receiving an indication of a signaling message including at least a partially dialed number, determining whether the dialed number is an incomplete number or a complete number associated with a user identity of a terminating user, forwarding, in response to a determination that the dialed number is the complete number, the signaling message to a call session control function associated with a location of the terminating user, and delaying forwarding of the signaling message until the dialed number is the complete number in response to a determination that the dialed number is the incomplete number.

In another exemplary embodiment, a computer program product for providing routing of message signaling is provided. The computer program product may include at least one computer-readable storage medium having computer-executable program code portions stored therein. The computer-executable program code portions may include a first program code instructions, second program code instructions, third program code instructions and fourth program code instructions. The first program code instructions may be for receiving an indication of a signaling message including at least a partially dialed number. The second program code instructions may be for determining whether the dialed number is an incomplete number or a complete number associated with a user identity of a terminating user. The third program code instructions may be for forwarding, in response to a determination that the dialed number is the complete number, the signaling message to a call session control function associated with a location of the terminating user. The fourth program code instructions may be for delaying forwarding of the signaling message until the dialed number is the complete number in response to a determination that the dialed number is the incomplete number.

In another exemplary embodiment, an apparatus for providing routing of message signaling is provided. The apparatus may include a processor that may be configured to receive an indication of a signaling message including at least a partially dialed number, determine whether the dialed number is an incomplete number or a complete number associated with a user identity of a terminating user, forward, in response to a determination that the dialed number is the complete number, the signaling message to a call session control function associated with a location of the terminating user, and delay forwarding of the signaling message until the dialed number is the complete number in response to a determination that the dialed number is the incomplete number.

In yet another exemplary embodiment an apparatus for providing routing of message signaling is provided. The apparatus may include means for receiving an indication of a signaling message including at least a partially dialed number, means for determining whether the dialed number is an incomplete number or a complete number associated with a user identity of a terminating user, means for forwarding, in response to a determination that the dialed number is the complete number, the signaling message to a call session control function associated with a location of the terminating user, and means for delaying forwarding of the signaling message until the dialed number is the complete number in response to a determination that the dialed number is the incomplete number.

In another exemplary embodiment, a method of providing routing of message signaling is provided. The method may include receiving an indication of a signaling message including a partially dialed number, determining an identity of an entity configured to perform a digit collection service regarding detection of a complete number, and providing an identity of the entity to a provider of the indication.

In another exemplary embodiment, a computer program product for providing routing of message signaling is provided. The computer program product may include at least one computer-readable storage medium having computer-executable program code portions stored therein. The computer-executable program code portions may include a first program code instructions, second program code instructions, and third program code instructions. The first program code instructions may be for receiving an indication of a signaling message including a partially dialed number. The second program code instructions may be for determining an identity of an entity configured to perform a digit collection service regarding detection of a complete number. The third program code instructions may be for providing an identity of the entity to a provider of the indication.

In another exemplary embodiment, an apparatus for providing routing of message signaling is provided. The apparatus may include a processor that may be configured to receive an indication of a signaling message including a partially dialed number, determine an identity of an entity configured to perform a digit collection service regarding detection of a complete number, and provide an identity of the entity to a provider of the indication.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a system according to an exemplary embodiment of the present invention;

FIG. 2 is a schematic block diagram showing an example implementation in the context of an exemplary IMS architecture according to an exemplary embodiment of the present invention;

FIG. 3 is a schematic block diagram of an apparatus for providing routing of message signaling according to an exemplary embodiment of the present invention;

FIG. 4 is a flowchart according to an exemplary method of providing routing of message signaling according to an exemplary embodiment of the present invention; and

FIG. 5 is a control flow diagram indicating messaging between various entities in relation to the provision of signaling message routing according to another exemplary embodiment.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

As discussed above, support for overlap dialing may be desirable in architectures supporting the provision of access to Internet services in a context where multiple access technologies may be used for network access, such as IMS. Some embodiments of the present invention will be described below in relation to a solution for improving signal routing in such a context. Although an exemplary embodiment will be described below in the context of IMS, it should be appreciated that embodiments may also be practiced in the context of other architectures as well.

There are currently several proposals for handling of overlap signaling within IMS. One such proposal is referred to as the “in-dialog” method. According to the in-dialog method, an entity within a network (e.g., an application server (AS)) may collect dialed numbers that arrive in various signaling messages (e.g., session initiation protocol (SIP) messages such as INVITE or INFO). The AS may then route a corresponding message forward once it is able (e.g., once the end of dialing is reached). In this regard, a problem may occur at the terminating side when the AS needs to be contacted. It may typically be assumed that an incoming INVITE request with an incomplete number is routed to a serving call session control function (S-CSCF), which may apply IMS filter criteria and send the request to the AS using normal IMS filtering. At this moment, however, the terminating user is not identified by the address in the INVITE request (e.g., the request uniform resource identifier (URI) may show an incomplete number) and therefore the S-CSCF does not know which filter criteria (which are bound to specific user profiles) to apply. Furthermore, it may not be clear to an interrogating CSCF (I-CSCF) of the architecture as to which of the S-CSCFs to route the incoming request, due to the incomplete number in the request URI. Thus, for example, the request may end up at a S-CSCF that does not serve the terminating user that is ultimately identified after all of the numbers identifying the user have been collected. Accordingly, once the end of dialing is reached, it may be possible for the AS to send the request to the S-CSCF that serves the user. However, efforts at call routing prior to the completion of dialing may lead to inefficiencies in relation to usage of network resources.

Accordingly, embodiments of the present invention may provide a mechanism by which routing may be delayed until a S-CSCF that serves the terminating user is clearly identified. As such, for example, a digit analyzing AS may be provided to allow requests to be initially analyzed by the digit analyzing AS, as allowed by IMS procedures when public service identity (PSI) based routing is employed.

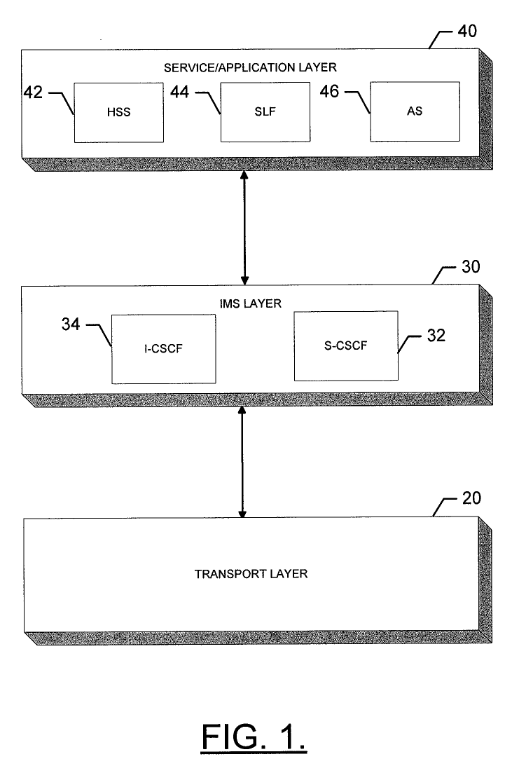

FIG. 1 is a schematic block diagram of a system according to an exemplary embodiment of the present invention. In this regard, FIG. 1 illustrates a general architecture of an IMS core network. The core network may be a collection of various different functions that may be in communication with each other via corresponding standardized interfaces. The various functions need not necessarily each form a corresponding single hardware node. Instead, various functions may be implemented at a single node or even split between two or more nodes. Thus, the illustration of FIG. 1 should be understood to be exemplary of a broad view of certain elements of the system and not an all inclusive or detailed view of the system.

Referring now to FIG. 1, an embodiment of a system in accordance with an exemplary embodiment of the present invention is illustrated. The system of FIG. 1 may include various layers such as a transport layer 20, an IMS layer 30 and a service/application layer 40. The transport layer 20 may have numerous functions and services. Among the functions of the transport layer 20 may include the receipt of IMS user plane data via any of numerous different access mechanisms. For example, mobile access mechanisms such as wideband code division multiple access (W-CDMA), CDMA2000, global system for mobile communications (GSM), general packet radio service (GPRS) may be supported as well as wireless access mechanisms such as wireless local area network (WLAN) and worldwide interoperability for microwave access (WiMAX) and fixed access mechanisms such as digital subscriber line (DSL), cable modems and Ethernet may all be supported by the transport layer 20. As such, the transport layer 20 may provide user agents capable of running SIP and IPv6 or IPv4 with access to services or applications via the IMS layer 30.

The IMS layer 30 may include various functions for providing IMS session signaling to enable access to the services or applications of the service/application layer 40. In an exemplary embodiment, the IMS layer 30 may include various call session control functions (CSCFs) such as, for example, one or more S-CSCFs (e.g., S-CSCF 32) and one or more I-CSCFs (e.g., I-CSCF 34).

The S-CSCF 32 may be embodied at a node such as a SIP server and is located in a home network of a user. Thus, for example, various S-CSCFs may be located in various home networks for respective different users. The S-CSCF 32 may be in communication with services or applications of the service/application layer 40 (e.g., a home subscriber server (HSS) such as HSS 42) to download or upload user profiles. The S-CSCF 32 may be configured to handle SIP registrations and bind user location (e.g., user IP address) to a SIP address. The S-CSCF 32 may also be configured to decide to which application servers of the service/application layer 40 a given SIP message is to be forwarded in order to receive corresponding services.

The I-CSCF 34 may be employed to serve as a forwarding point for SIP packets. In this regard, for example, the I-CSCF 34 may be embodied at a server or other node configured to, among other things, communicate with the service/application layer 40 (e.g., the HSS 42) via an interface (e.g., a Diameter Cx interface) in order to query the HSS 42 to receive the user location in order to route a SIP request to the correct S-CSCF (e.g., the S-CSCF of the user's location).

The service/application layer 40 may perform services and include applications accessible to users via lower layers. In an exemplary embodiment, the service/application layer 40 may include the HSS 42, a subscriber location function (SLF) 44, and one or more application servers (e.g., AS 46). The HSS 42 may include a master user database for use by network entities that handle calls. The HSS 42 may store user profiles, provide information regarding user location and/or perform user authentication and authorization. If multiple HSSs are used, the SLF 44 may also be employed to map user addresses. Various different identities may typically be used to identify users such as international mobile subscriber identity (IMSI), temporary mobile subscriber identity (TMSI), international mobile equipment identity (IMEI), mobile station integrated services digital network (MSISDN) number (e.g., user telephone number), IP multimedia private identity (IMPI), IP multimedia public identity (IMPU), and/or the like. In an exemplary embodiment, the HSS 42 (and/or the SLF 44) may use IMPI and/or IMPU, which may be URIs. However, some embodiments may include the provision of a new type of address that may be configured as “incomplete number”, for use as described in greater detail below.

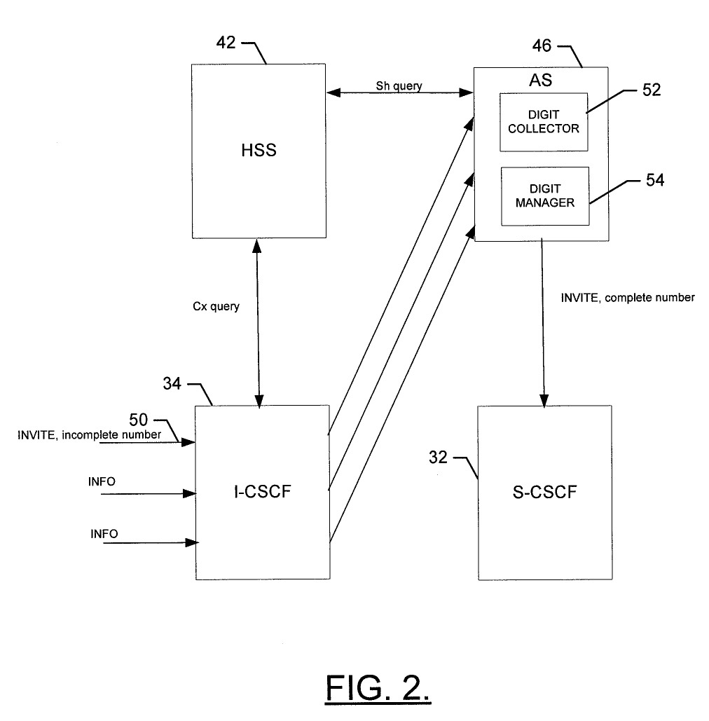

The application servers host and execute various services. Thus, the application servers may provide users with access to the services via interface with the S-CSCF 32. The application servers can typically operate in various different modes dependent upon the service being provided. For example, the AS 46, which is an example of an application server, may be configured to enable operation in a SIP proxy mode, a SIP user agent mode, or a SIP back-to-back user agent (SIP B2BUA) mode. An exemplary embodiment of the present invention will now be described in greater detail in reference to FIG. 2, which is a block diagram showing implementation of an embodiment of the present invention in the context of an exemplary IMS architecture.

FIG. 2 shows various exemplary functions or entities from the embodiment of FIG. 1 in communication with each other according to an exemplary embodiment. In this regard, as shown in FIG. 2, the I-CSCF 34 may be configured to receive a signaling message 50 such as an INVITE message (or other request for the home network of the terminating user) with an incomplete number. Other information corresponding to the signaling message 50 may also be received by the I-CSCF 34. Upon receipt of the request, the I-CSCF 34 may perform a location information request (LIR) query via the Cx interface (e.g., interface between HSS and CSCF functions) with the HSS 42 (or the SLF 44) as specified for example in the Third Generation Partnership Project technical specification (3GPP TS) 29.228 and 3GPP TS 29.229. The I-CSCF 34 may normally receive back from the HSS 42 an address or identification of the S-CSCF 32 serving the terminating user. However, if the first digits or characters of the number being dialed at the originating user's terminal (or user equipment UE) are not complete, the incomplete number may be detected at the HSS 42. In this regard, for example, the HSS 42 may include incomplete numbers mapped to various application servers. As such, for example, the HSS 42 may recognize the incomplete number and provide the I-CSCF 34 with a configured address of an application server that is available (e.g., the AS 46). The identity of the AS 46 may be provided in a location information answer (LIA) in response to the query via the Cx interface and may be in the form of a URI or other identification mechanism.

The I-CSCF 34 may route the request to the AS 46 (e.g., a B2BUA AS) identified by the HSS 42. The AS 46 may include a digit collector 52 and a digit manager 54. The digit collector 52 may be configured to perform digit (or other character) analysis until an end of dialing is recognized. Once the digit collector 52 recognizes that the AS 46 has received a complete number, the AS 46 (e.g., via the digit manager 54) may query the HSS 42 (or the SLF 44) via Sh-pull procedures as described, for example, in 3GPP TS 29.328 and 3GPP TS 29.329. In this regard, for example, the AS 46 may provide a Sh query via the Sh interface (e.g., interface between the AS and HSS) to find out the S-CSCF serving the terminating user. The HSS 42 may provide a response to the Sh query identifying the S-CSCF 32. The AS 46 may then forward the request with the complete number to the corresponding S-CSCF (e.g., S-CSCF 32). The S-CSCF 32 may thereafter provide services based on terminating filter criteria for the terminating user.

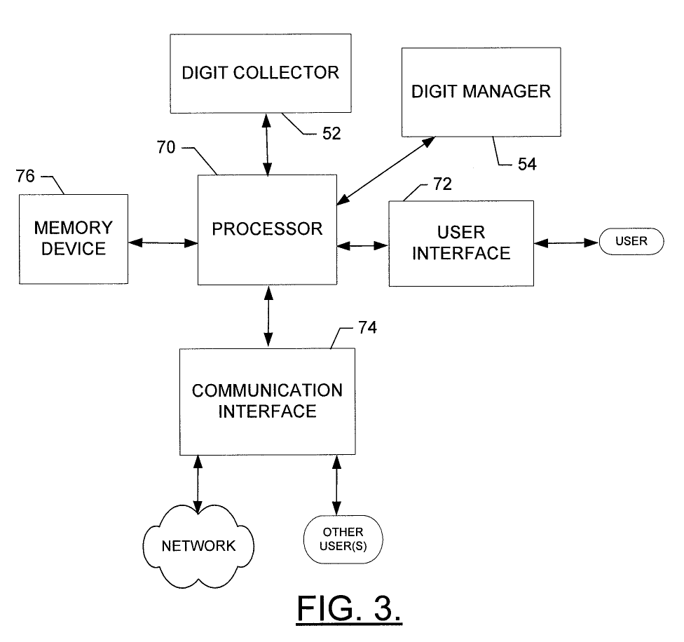

FIG. 3 illustrates an exemplary apparatus for providing routing of a signaling message according to one embodiment of the present invention. Referring now to FIG. 3, an apparatus for providing routing of a signaling message is provided. The apparatus may in some cases include or be embodied as a server or other communication device. As indicated above, although the apparatus of FIG. 3 may be configured to perform the functions of the AS 46 with digit collection capability, the apparatus may also have numerous other functions. The apparatus may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, and/or the like. In an exemplary embodiment, the processor 70 may be configured to execute instructions stored in the memory device 76 or otherwise accessible to the processor 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and/or supporting hardware and/or software for enabling communications with a wired or wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms. In an exemplary embodiment, the communication interface 74 may be configured to enable communication with various other functions or devices including, for example, the HSS 42 (e.g., via the Sh interface), the S-CSCF 32, the I-CSCF 34, and/or the like.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a touch screen, a display, a microphone, a speaker, or other input/output mechanisms. In an exemplary embodiment in which the apparatus is embodied as a server, access point or some other network devices, the user interface 72 may be limited, or eliminated.

In an exemplary embodiment, the processor 70 may be embodied as, include or otherwise control the digit collector 52 and the digit manager 54. The digit collector 52 and the digit manager 54 may each be any means such as a device or circuitry embodied in hardware, software or a combination of hardware and software that is configured to perform the corresponding functions of the digit collector 52 and the digit manager 54, respectively, as described below. However, in some embodiments, the functions of both the digit collector 52 and the digit manager 54 may be performed by a single entity configured to perform the corresponding functions of both the digit collector 52 and the digit manager 54.

The digit collector 52 may be configured to receive incoming numbers (or groups of characters) and determine whether or not such numbers are complete. As indicated above, the digit collector 52 may perform the determination by any of various mechanisms such as, for example, by recognizing an end of dialing. In an exemplary embodiment, the digit collector 52 may include a configured address for available application servers based at least in part on the incomplete number provided. The digit collector 52 may be further configured to provide the number received along with an indication of whether the number is complete or incomplete to the digit manager 54.

The digit manager 54 may be configured to interface with (or direct the AS 46 to interface with) a respective other server or function based on whether a dialed number received in association with a request is complete or incomplete. For example, if the dialed number is incomplete, the digit manager 54 may be configured to delay communication of a query to the HSS 42 to determine an S-CSCF to which the request is to be forwarded until the dialed number is complete. Accordingly, once the digit manager 54 receives an indication of a determination made by the digit collector 52 that the dialed number is complete, the digit manager 54 may be configured to communicate the Sh query to the HSS 42 to enable a determination regarding to which S-CSCF the request is to be forwarded. After receiving a response from the HSS 42 identifying the S-CSCF 32 of the terminating user, the digit manager 54 may be configured to communicate (or direct the AS 46 to communicate) the request to the identified S-CSCF 32.

Accordingly, embodiments of the present invention may provide for improved overlap dialing response without impacting existing S-CSCF implementation while avoiding inclusion of unnecessary nodes in a call chain. Furthermore, embodiments of the present invention may provide that only one instance of S-CSCF (e.g., the one that serves the terminating user) is in the call chain to reduce processing load.

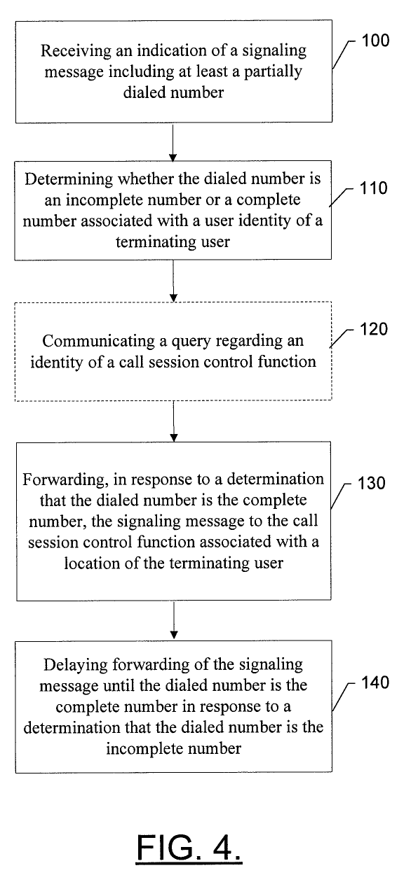

FIG. 4 is a flowchart of a system, method and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device and executed by a processor (e.g., the processor 70). As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing signaling message routing as provided in FIG. 4 may include receiving an indication of a signaling message including at least a partially dialed number at operation 100 and determining whether the dialed number is an incomplete number or a complete number associated with a user identity of a terminating user at operation 110. In an exemplary embodiment, the method may further include forwarding, in response to a determination that the dialed number is the complete number, the signaling message to a call session control function associated with a location of the terminating user at operation 130. The method may also include delaying forwarding of the signaling message until the dialed number is the complete number in response to a determination that the dialed number is the incomplete number at operation 140.

In some embodiments, the method may include further optional operations, an example of which is shown in dashed lines in FIG. 4. In this regard, the method may further include communicating a query regarding an identity of the call session control function at operation 120. In an exemplary embodiment, forwarding the signaling message may include forwarding the signaling message to the call session control function identified in response to the communication of the query.

In an exemplary embodiment, the signaling message may be a SIP signaling message or a request URI. Furthermore, the receipt of the indication of the signaling message may, in some cases, include receiving the indication at an application server within an IMS core network that is selected based on the incomplete number. In some instances, determining whether the dialed number is the complete number may include recognizing an end of dialing with respect to the dialed number.

In an exemplary embodiment, an apparatus for performing the method above may include a processor (e.g., the processor 70) configured to perform each of the operations (100-140) described above. The processor may, for example, be configured to perform the operations by executing stored instructions or an algorithm for performing each of the operations. Alternatively, the apparatus may include means for performing each of the operations described above. In this regard, according to an exemplary embodiment, examples of means for performing operations 100 to 140 may include, for example, respective ones of the digit collector 52, the digit manager 54, or the processor 70.

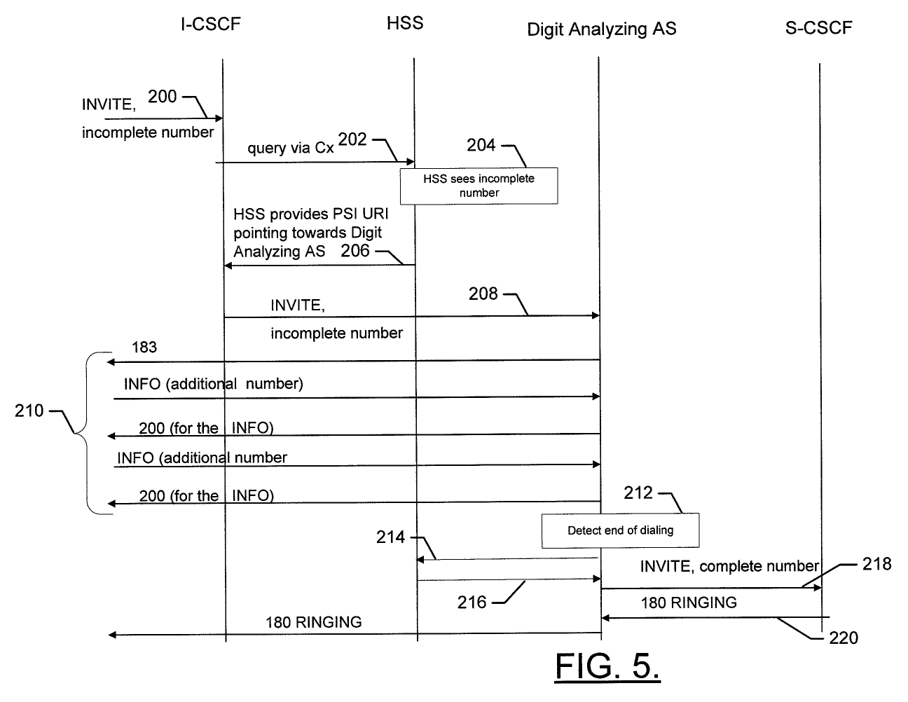

FIG. 5 is a control flow diagram indicating messaging between various ones of the entities described above in relation to the provision of signaling message routing according to another exemplary embodiment. In this regard, while FIG. 4 primarily examines actions of the AS 46, FIG. 5 further illustrates messaging involving the HSS 42, the I-CSCF 34 and the S-CSCF 32 as described in greater detail above in reference to FIG. 2. In this regard, as shown in FIG. 5, the I-CSCF may initially receive an INVITE message with an incomplete number at operation 200. The I-CSCF may perform a LIR query via the Cx interface to the HSS at operation 202. The HSS may see that the provided number is incomplete by referencing a dial plan covering incomplete numbers at operation 204. The dial plan may provide a reference of numbers, including incomplete numbers, against which provided numbers may be matched. In some embodiments, matching an incomplete number may be the last match made (e.g., when no other user is found). For the incomplete number, the HSS may then provide a matched identity of an AS having digit collection capability in order to enable detection of completion of dialing. The identity may include, for example, a public service identity (PSI) of the AS having digit collection capability (e.g., a URI of the digit collecting AS) providing the digit collection service, which may be provided to the I-CSCF at operation 206. The I-CSCF may then forward the INVITE message with the incomplete number to the identified AS at operation 208. Following receipt of the INVITE message with the incomplete number, the AS may perform operations and/or signaling at operation 210 to enable a detection of the end of dialing (e.g., completion of the number) at operation 212. The AS may then perform an Sh query to determine the S-CSCF for the complete number at operation 214 and receive an identity of the S-CSCF at operation 216. The INVITE message with a complete number may then be forwarded to the S-CSCF at operation 218 and ringing may begin as shown in operation 220.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an indication of a signaling message including at least a partially dialed number;
determining whether the dialed number is an incomplete number or a complete number associated with a user identity of a terminating user;
forwarding, in response to a determination that the dialed number is the complete number, the signaling message to a call session control function associated with a location of the terminating user; and
delaying forwarding of the signaling message until the dialed number is the complete number in response to a determination that the dialed number is the incomplete number.

2. The method of claim 1, further comprising communicating a query regarding an identity of the call session control function.

3. The method of claim 2, wherein forwarding the signaling message comprises forwarding the signaling message to the call session control function identified in response to the communication of the query.

4. The method of claim 1, wherein receiving the indication of the signaling message comprises receiving a session initiation protocol message.

5. The method of claim 1, wherein receiving the indication of the signaling message comprises receiving a request uniform resource identifier.

6. The method of claim 1, wherein receiving the indication of the signaling message comprises receiving the signaling message in an Internet protocol multimedia subsystem (IMS) core network.

7. The method of claim 1, wherein determining whether the dialed number is the complete number comprises recognizing an end of dialing with respect to the dialed number.

8. A computer program product comprising at least one computer-readable storage medium having computer-executable program code portions stored therein, the computer-executable program code instructions comprising:
first program code instructions for receiving an indication of a signaling message including at least a partially dialed number;
second program code instructions for determining whether the dialed number is an incomplete number or a complete number associated with a user identity of a terminating user;
third program code instructions for forwarding, in response to a determination that the dialed number is the complete number, the signaling message to a call session control function associated with a location of the terminating user; and
fourth program code instructions for delaying forwarding of the signaling message until the dialed number is the complete number in response to a determination that the dialed number is the incomplete number.

9. The computer program product of claim 8, further comprising fifth program code instructions for communicating a query regarding an identity of the call session control function.

10. The computer program product of claim 9, wherein the third program code instructions include instructions for forwarding the signaling message to the call session control function identified in response to the communication of the query.

11. The computer program product of claim 8, wherein the first program code instructions include instructions for receiving a session initiation protocol message.

12. The computer program product of claim 8, wherein the first program code instructions include instructions for receiving a request uniform resource identifier.

13. The computer program product of claim 8, wherein the first program code instructions include instructions for receiving the signaling message in an Internet protocol multimedia subsystem (IMS) core network.

14. The computer program product of claim 8, wherein the second program code instructions include instructions for recognizing an end of dialing with respect to the dialed number.

15. An apparatus comprising a processor configured to:
receive an indication of a signaling message including at least a partially dialed number;
determine whether the dialed number is an incomplete number or a complete number associated with a user identity of a terminating user;
forward, in response to a determination that the dialed number is the complete number, the signaling message to a call session control function associated with a location of the terminating user; and
delay forwarding of the signaling message until the dialed number is the complete number in response to a determination that the dialed number is the incomplete number.

16. The apparatus of claim 15, wherein the processor is further configured to communicate a query regarding an identity of the call session control function.

17. The apparatus of claim 16, wherein the processor is configured to forward the signaling message by forwarding the signaling message to the call session control function identified in response to the communication of the query.

18. The apparatus of claim 15, wherein the processor is configured to receive the indication of the signaling message by receiving a session initiation protocol message.

19. The apparatus of claim 15, wherein the processor is configured to receive the indication of the signaling message by receiving a request uniform resource identifier.

20. The apparatus of claim 15, wherein the processor is configured to receive the indication of the signaling message by receiving the signaling message from an interrogating call session control function in an Internet protocol multimedia subsystem (IMS) core network.

21. The apparatus of claim 15, wherein the processor is configured to determine whether the dialed number is the complete number comprises recognizing an end of dialing with respect to the dialed number.

22. An apparatus comprising:
means for receiving an indication of a signaling message including at least a partially dialed number;
means for determining whether the dialed number is an incomplete number or a complete number associated with a user identity of a terminating user;
means for forwarding, in response to a determination that the dialed number is the complete number, the signaling message to a call session control function associated with a location of the terminating user; and
means for delaying forwarding of the signaling message until the dialed number is the complete number in response to a determination that the dialed number is the incomplete number.

23. A method comprising:
receiving an indication of a signaling message including a partially dialed number;
determining an identity of an entity configured to perform a digit collection service regarding detection of a complete number; and
providing an identity of the entity to a provider of the indication.

24. The method of claim 23, wherein the determining comprises referencing a dial plan covering incomplete numbers, in which the dial plan includes a match between the identity of the entity and the incomplete number.

25. The method of claim 23, wherein providing the identity comprises providing a uniform resource identifier of an application server configured to perform the digit collection service.

26. A computer program product comprising at least one computer-readable storage medium having computer-executable program code portions stored therein, the computer-executable program code instructions comprising:
first program code instructions for receiving an indication of a signaling message including a partially dialed number;
second program code instructions for determining an identity of an entity configured to perform a digit collection service regarding detection of a complete number; and
third program code instructions for providing an identity of the entity to a provider of the indication.

27. The computer program product of claim 26, wherein the second program code instructions include instructions for referencing a dial plan covering incomplete numbers, in which the dial plan includes a match between the identity of the entity and the incomplete number.

28. The computer program product of claim 26, wherein the third program code instructions include instructions for providing a uniform resource identifier of an application server configured to perform the digit collection service.

29. An apparatus comprising a processor configured to:
receive an indication of a signaling message including a partially dialed number;
determine an identity of an entity configured to perform a digit collection service regarding detection of a complete number; and
provide an identity of the entity to a provider of the indication.

30. The apparatus of claim 29, wherein the processor is configured to determine the identity of the entity by referencing a dial plan covering incomplete numbers, in which the dial plan includes a match between the identity of the entity and the incomplete number.

31. The method of claim 29, wherein the processor is configured to provide the identity by providing a uniform resource identifier of an application server configured to perform the digit collection service.
